(19) United States
(12) Patent Application Publication
(10) Pub. No.: US 2011/0072694 A1
(43) Pub. Date: Mar. 31, 2011

(54) AUTOGRAPHABLE CARD-TYPE MEMORABILIA

(75) Inventors: Lyle Bowen, Albert Lea, MN (US); Robert Weiss, Albert Lea, MN (US)

(73) Assignee: PenPals, LLC, Albert Lea, MN (US)

(21) Appl. No.: 12/570,306

(22) Filed: Sep. 30, 2009

(51) Int. Cl. G09F 1/04; B05D 7/24; B32B 37/14; B32B 38/00; B05D 5/04; G09F 1/00; G09F 3/10

(52) U.S. Cl. 40/124.09; 156/278; 156/256; 156/227; 40/124.01; 40/638

(57) ABSTRACT

A card-type memorabilia article including a photographic print paper intermediate layer, a urethane top layer, and an ink-receptive laminate. The intermediate layer defines opposing, first and second major surfaces, and displays a photographic image on the first major surface. The urethane top layer is applied over the first major surface. The ink-receptive laminate is applied over the second major surface, with the laminate defining an outer face. The ink-receptive coating protects ink that is written onto the outer face from smudging and smearing. The high quality photographic image is environmentally protected by the urethane layer, whereas the laminate not only protects against water damage, but also receives autographs or other ink-created marking without smudging or smearing.

### BACKGROUND

The present disclosure relates to card-type memorabilia articles. More particularly, it relates to weather-resistant memorabilia cards or tags displaying an image of a person and/or event, and amenable to receiving an ink-applied marking such as an autograph.

Memorabilia items such as promotional and collectible cards are used in many fields and typically comprise pictures of celebrities, athletes, and/or events. Collectible paperboard baseball cards are but one example. Other, more rigid formats are also popular, and sometimes referred to as “tags”. Regardless, memorabilia cards, tags, and other card-type formats are greatly desired by consumers.

In many instances, the intrinsic value or enjoyment of a particular card-type memorabilia article to it's owner is enhanced by a hand-written autograph or other ink-applied marking. For example, the market value of a popular baseball player's baseball card can be increased when autographed by the player. An autographed photograph of a celebrity is normally viewed as being more personal, and thus more treasured, than the photograph alone. As yet another example, attendees at professional golf events may purchase or be given a “bag tag” that displays a picture of the golf course and/or one or more players participating in the event. The owner of the bag tag may meet one or more players during the event, and desire to have the player's autograph the tag, perhaps in hopes of better remembering the meeting. In more general terms, then, obtaining the autograph of a celebrity on a card-type memorabilia article is desired, as is the long-term stability of the autograph and of the article itself.

While the autographing of card-type memorabilia is commonplace, current formats are less than optimal. For example, conventional collector cards comprise images printed directly onto paper substrates by conventional printing methods. However, due to constraints in the printing processes, the image quality produced is less than desirable. Further, the paper substrate is not protected from the environment, can inadvertently be folded, and is otherwise easily damaged. Further, an ink-applied autograph will smudge or smear. While large, glossy photographs may have enhanced image quality, they are quite delicate, and an ink-applied autograph will again smudge or smear. Conversely, while plastic or otherwise rigid tags are vinyl-backed and thus more durable, the tag material is not ink-receptive, and an applied autograph will easily smudge, smear or wipe away.

In light of the above, a need exists for card-type memorabilia articles displaying high quality image that are weather-resistant and durable, and cleanly receive and maintain ink-applied markings such as autographs.

### SUMMARY

One aspect in accordance with principles of the present disclosure relates to a card-type memorabilia article including a photographic print paper intermediate layer, a urethane top layer, and an ink-receptive laminate bottom layer. The intermediate layer defines opposing, first and second major surfaces, and displays a photographic image on the first major surface. The urethane top layer is applied over the first major surface. The ink-receptive laminate is applied over the second major surface and defines an outer face. The laminate includes an ink-receptive coating and a water-resistant material. In this regard, the ink-receptive coating protects ink that is written onto the outer face from smudging and smearing. The resultant article can have a variety of different shapes and sizes, and can be used in retail markets, premium markets, secondary markets, etc. Regardless, the high quality photographic image is environmentally protected by the urethane layer, whereas the laminate not only protects against water damage, but also receives autographs or other ink-created marking without smudging or smearing. In some embodiments, the ink receptive laminate is an adhesive-backed label that is laminated to the photographic print paper intermediate layer. In other embodiments, the image displayed by the photographic print paper relates to a sporting event or sports celebrity. In yet other embodiments, the article is foldable along one or more fold lines from a flat state to a folded state in which the article can be free standing on a flat surface.

Yet other aspects in accordance with principles of the present disclosure relate to a method of manufacturing a card-type memorabilia article. The method includes providing a photographic print paper layer defining opposing, first and second major surfaces and displaying an image on the first major surface. A layer of urethane is coated over the first major surface, and an ink-receptive laminate is applied over the second major surface. In this regard, the image is visible through the urethane layer, and an exposed face of the ink-receptive laminate is constructed to receive ink markings in a substantially smudge-free manner. In some embodiments, the ink-receptive laminate is a label cut from a sheet of ink-receptive laminate material, with the label being die cut to a perimeter shape corresponding with a perimeter shape of the photographic print paper layer. The so-formed label is then bonded to the photographic print paper layer. In other embodiments, the urethane is coated to a thickness of at least 1/32 inch.

### BRIEF DESCRIPTION OF THE DRAWINGS

FIG. 1 is a front view of an autographable card-type memorabilia article in accordance with principles of the present disclosure;

FIG. 1B is a rear view of the article of FIG. 1A;

FIG. 2 is a cross-sectional view of the article of FIG. 1A;

FIG. 3 is a cross-sectional view of one construction at an ink-receptive laminate useful with the article of FIG. 1A;

FIG. 4 is a flow diagram of a method in accordance with principles of the present disclosure for manufacturing an autographable card-type memorabilia;

FIG. 5 illustrates one embodiment of a formation of an ink-receptive laminate useful with the article of FIG. 1A; and

FIG. 6 is a perspective view of another autographable card-type memorabilia article in accordance with principles of the present disclosure.

### DETAILED DESCRIPTION

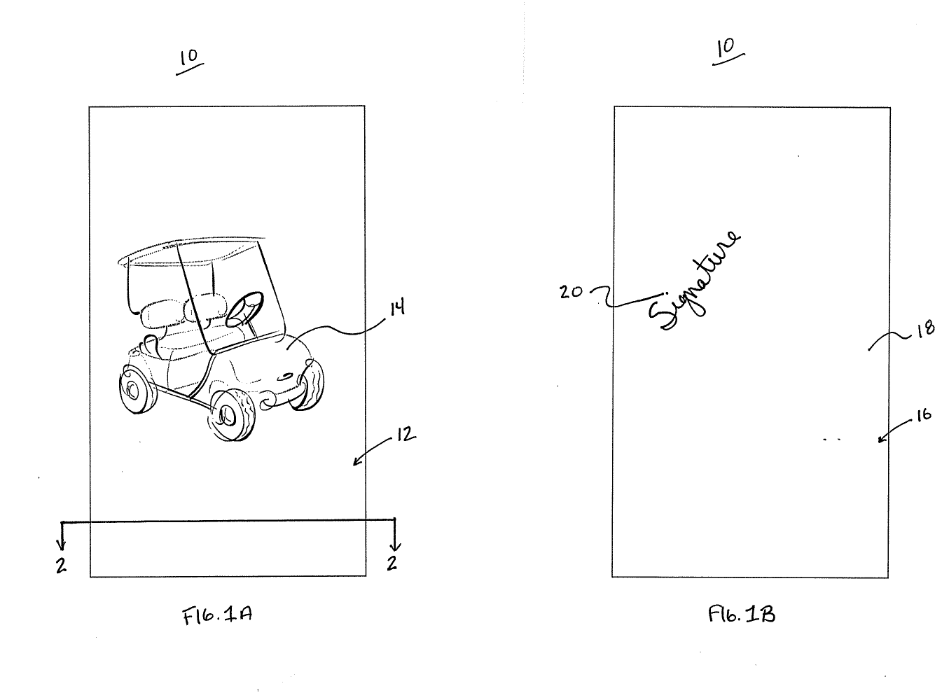

One embodiment of a card-type memorabilia article 10 in accordance with the present disclosure is shown in FIGS. 1A and 1B. The term “card-type” is in reference to cards, tags, sheets, or other conventional memorabilia formats that are relatively flat or two-dimension (though can be folded or otherwise transitioned from the flat state as described elsewhere). The article 10 defines a front side 12 (FIG. 1A) at (or through) which an image 14 is visible. A back side 16 (FIG. 1B) is also defined, and provides an ink-receptive face 18 capable of receiving and maintaining an ink-created marking 20 thereon. The ink marking 20 is an autograph in FIG. 1B, though a variety of other markings could be created. Regardless, the ink marking 20 itself is not part of the inventive article 10. Rather, some inventive aspects reside in an ability of the ink-receptive face 18 to cleanly receive and maintain ink. The article 10 is relatively rigid, and the image 14 is protected from various environmental conditions such as water. The subsequently-applied ink marking 20 is also protected from water damage, and is generally free of smudging or smearing.

The card-type memorabilia article 10 can be akin (in terms of size and shape) to conventional sport collector cards, thus having a rectangular perimeter shape. A wide variety of other sizes and perimeter shapes are also within the scope of the present disclosure. Virtually any size (e.g., ranging from 1 inch in minor dimension to 20 inches in major dimension) or shape (e.g., curved perimeter, non-symmetrical shapes, irregular shapes, etc.) can be employed. Thus, memorabilia articles in accordance with the present disclosure are card-like in shape and size (e.g., relatively flat), and can alternatively be referred to as “tags”.

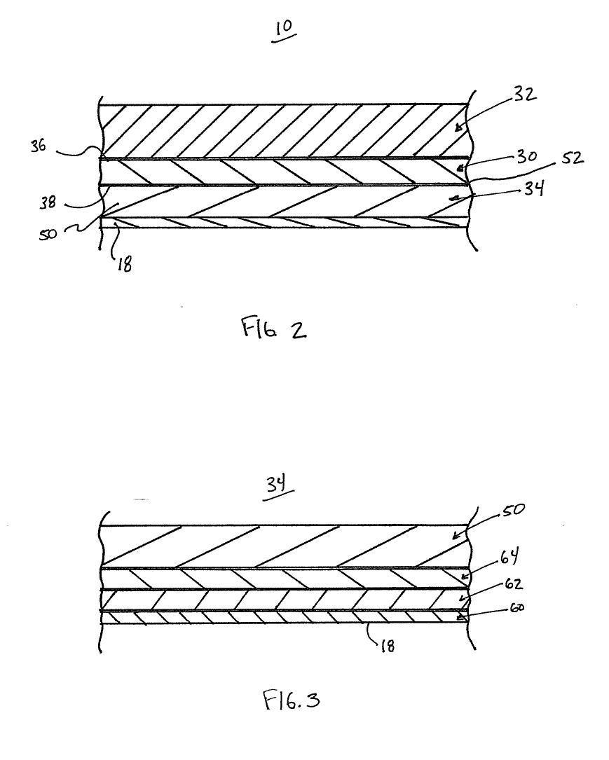

With reference to FIG. 2, the memorabilia article 10 includes an intermediate layer 30, a top layer 32, and a bottom layer 34 in some embodiments. The intermediate layer 30 is a photographic print paper defining opposing, first and second major surfaces 36, 38. The image 14 (FIG. 1A) is displayed on the first major surface 36 pursuant to conventional photographic printing techniques. The photographic print paper intermediate layer 30 can be of any type conventionally employed (e.g., negative/positive or positive/positive print techniques), and conventionally includes a paper-based substrate coated with an emulsion. In this regard, the paper base of resin-coated papers is optionally sealed by two polyethylene layers, making it impenetratable to liquids. Alternatively, photographic materials or emulsion can be coated on a solid polyester material. Regardless, the photographic print paper intermediate layer 30 is substantially free of oil, and is water-soluble.

The image 14 (FIG. 1A) formed on the photographic print paper intermediate layer 30 can assume a wide variety of forms as desired. Thus, the image 14 can be or include a picture of a celebrity (e.g., a sports celebrity), an event, logo, scenery, fanciful images, etc.

The top layer 32 is urethane, and in some embodiments is coated directly onto the first major surface 36 of the photographic print paper intermediate layer 30. The urethane layer 32 is sufficiently transparent for viewing of the image 14 (FIG. 1A) on the photographic print paper 30, yet protects the image 14 from damage when the article 10 is exposed to water, sun, etc. In some constructions, the urethane top layer 32 is coated to a thickness of at least 1/32 inch, and in other constructions a thickness of 1/16 inch, and the article 10 relatively rigid and durable (e.g., apart from any pre-made fold lines described below, the urethane top layer 32 is sufficiently rigid to prevent permanent creasing of the article 10 in the presence of normal handling forces). Optionally, one or more additional transparent material layers can be disposed between the urethane top layer 32 and the first major surface 36 to provide further structural rigidity and/or enhanced attachment between the urethane top layer 32 and the photographic print paper intermediate layer 30. Urethane is a mercury-free compound, rendering the article 10 child-safe.

The bottom layer 34 is applied over the second major surface 38 of the photographic print paper layer 30, and in some constructions is an ink-receptive laminate. With this in mind, FIG. 2 reflects the laminate bottom layer 34 as including a substrate 50 and the ink-receptive face 18. In general terms, the ink-receptive face 18 is formed on or by the substrate 50, with the substrate 50 affixed to the second major surface 38 of the photographic print paper 30 such as with an adhesive 52. In some embodiments, the laminate layer 34 is an ink-receptive, water-resistant, adhesive-backed label, such as water-resistant labels available from 3M Company of St. Paul, Minn. or Avery Dennison Corp. of Pasadena, Calif. The substrate 50 can be any of those normally employed for ink receptors, such as paper, resin-coated paper, plastics such as polyester-type resins, such as a polyester terephthalate (PET), or polyester naphthalene (PEN), polyethylene resins, polypropylene resins, polyolefin resins, vinyl chloride resins, polycarbonate resins, various glass materials, and known microporous materials. Antioxidants, antistatic agents, plasticizers, and/or other known additives can be incorporated into the substrate 50, if desired.

Regardless of composition, the substrate 50 is flat, and is formed to a thickness appropriate for application to the photographic print paper layer 30. While the substrate 50 is illustrated in FIG. 2 as being a single material layer, in alternative embodiments, the substrate 50 can include two or more layers.

In some constructions, the ink-receptive face 18 is formed as a coating on the substrate 50 (e.g., coating, drying and curing of one or more solutions and/or dispersions). With this approach, the ink-receptive face 18 can comprise known ink-receptive materials, such as inorganic particles (e.g., silica, alumina, etc.), and a binder, such as polyvinyl alcohol, polyvinyl acetate, and gelatin to name but a few. While the ink-receptive face 18 is shown in FIG. 2 as being a single layer, in alternative embodiments, the ink-receptive face 18 can consist of two or more layers.

The ink-receptive face 18 can be formed onto the substrate 50 in various manners. For example, a primer can first be coated onto the substrate 50, followed by the ink-receptive face 18. Regardless, the ink-receptive coating is formulated to protect ink applied thereto, such that the ink does not easily smear or smudge. The ink-receptive coating may be suitable for receiving gel-based ink from gel ink pens. In one embodiment of a clear gel ink-receptive coating, the coating may comprise 30-100% of water-soluble components, and 0-70% of water-insoluble pigments. The water-soluble components can comprise: (1) 60-90% of at least one non-ionic water soluble polymer, (2) 2-40% of an ampheroteric polymers, and (3) up to 10% of various additives. Suitable primers are known in the art. For example, the primer may be an acrylic polymer primer, or a polyurethane primer. In other embodiments, the ink-receptive coating is suitable for receiving ink from a conventional ball point pen or a permanent marker, and can comprise a mixture of one or more water-soluble polymers (e.g., polyvinyl alcohol) and a surfactant. Other additives, such as pigments, can also be included. A separate, water-absorbent material or layer and/or a water-resistant material or layer can also be incorporated into the laminate 34. For example, and as shown in FIG. 3, the laminate 34 can include an ink-receiving and fixing layer 60 comprised of a material capable of fixing the dyes in the ink, while allowing excess water to pass through the layer. A water absorbent layer 62 comprised of a highly porous material that can instantly absorb the water in an ink, without swelling, is also provided. Finally, a water-resistant layer 64 is provided and prevents water-based inks from penetrating into the substrate 50.

The adhesive 52 can be any appropriate adhesive for bonding the substrate 50 to the photographic print paper layer 30 (or an additional material disposed therebetween). Thus, the adhesive 52 can be a pressure sensitive adhesive commonly used with labels. Other suitable adhesives include, but are not limited to, acrylate-based adhesives, UV-curable adhesives, temperature cured adhesives, moisture cured adhesives, and/or reactive adhesives such as epoxies.

Regardless of an exact form, and returning to FIG. 2, the laminate 34 is weather- and water-resistant, and provides the ink-receptive face 18.

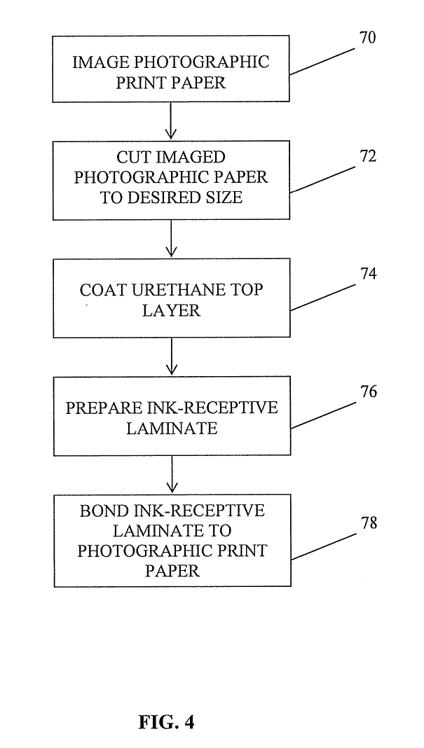

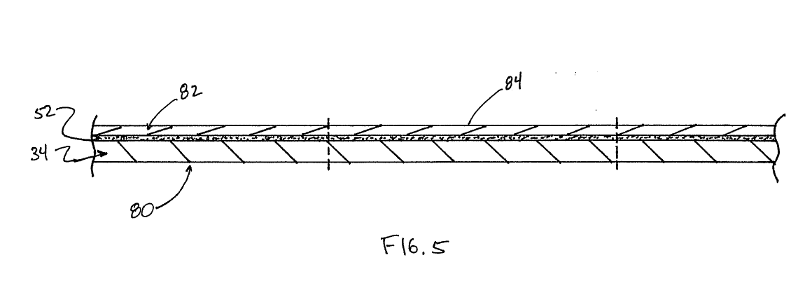

The card-type memorabilia article 10 can be constructed in a variety of manners. In one embodiment, and with reference to FIG. 4, the photographic print paper 30 is printed (e.g., known photography step) to form the desired image 14 at step 70. The photographic print paper 30 is optionally cut to a desired size and shape at step 72. At 74, the urethane top layer 32 is then coated onto the first major surface 36 of the photographic print paper 30. In this regard, conventional urethane coating techniques can be employed in which the urethane is heated to its melting point, and then dispensed or poured onto the photographic print paper 30. Because the photographic print paper 30 is substantially free of oil and therefore water soluble, the coated urethane will not bubble and has a uniform thickness upon hardening. Further, urethane is self-sealing to the photographic print paper 30. Where desired, the urethane-coated photographic print paper can be cut to a desired shape and/or size.

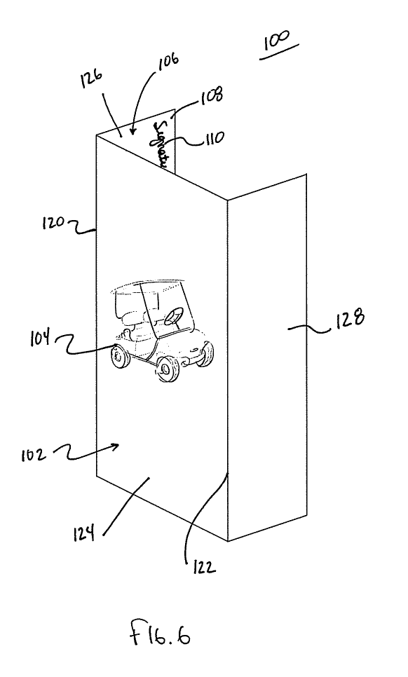

The ink-receptive laminate 34 is then prepared in accordance with a size and shape of the photographic print paper 30 at 76. For example, in some embodiments, the ink-receptive laminate 34 is die cut from a sheet of label stock 80 as shown in FIG. 5. The label stock sheet 80 includes the laminate material coated with the adhesive 52, as well as a release liner 82. A label 84 is die cut from the label stock sheet 80 to a perimeter shape corresponding with the perimeter shape of the photographic print paper 30. The release liner 82 is peeled from the label 84, thereby exposing the adhesive 52. Returning to FIG. 4, at step 78 the laminate 34 is bonded to the second major surface 38 of the photographic print paper intermediate layer 30 (or an optional intervening layer) via the adhesive 52, resulting in the article 10. Other techniques for applying the ink-receptive laminate 34 are also envisioned, such as applying an adhesive to the photographic print paper intermediate layer 30, followed by direct application of the substrate 50 of the laminate 34 thereto.

While the card-type memorabilia article 10 has been illustrated as being substantially flat, in other embodiments, one or more fold lines or other features can be included. For example, FIG. 6 illustrates another embodiment of a card-type memorabilia article 100 in accordance with principles of the present disclosure, and again includes a front side 102 displaying an image 104 via photographic print paper intermediate layer, and a back side 106 providing an ink-receptive face 108 for receiving an ink marking 110 (e.g., autograph) in a non-smudging and non-smearing manner. The article 100 includes two fold lines 120, 122 extending along a length thereof so as to define a central region 124 and opposing side regions 126, 128. With this construction, the side regions 126, 128 can be folded relative to the central region 124 along the fold lines 120, 122, and the resulting format is conducive for placement on a flat surface, self-maintaining an upright position. A wide variety of other fold line-type constructions can alternatively be incorporated. Regardless, to facilitate ease of folding the urethane top layer 32 (FIG. 2) has a reduced thickness along the fold lines 120, 122, and in some embodiments is absent or removed from the fold lines 120, 122. Thus, the hardened urethane top layer 32 does not overtly resist or prevent bending of the article 100 along the fold lines 120, 122. The reduced-thickness urethane top layer 32 can be achieved in various manners, for example by employing a baffle during the coating process that keeps the melted urethane off of the fold lines 120, 122 that can otherwise be pre-formed in the photographic print paper 30.

Although the present disclosure has been described with reference to preferred embodiments, workers skilled in the art will recognize that changes can be made in form and detail without departing from the spirit and scope of the present disclosure.

What is claimed is:

1. A card-type memorabilia article comprising:
a photographic print paper intermediate layer defining opposing, first and second major surfaces and displaying a photographic image on the first major surface;
a urethane top layer applied over the first major surface; and
an ink-receptive laminate applied over the second major surface, the laminate defining an outer face and including an ink-receptive coating and a water-resistant material, wherein the ink-receptive coating receives and protects ink subsequently applied onto the outer face from smudging and smearing.

2. The memorabilia article of claim 1, wherein the ink-receptive laminate is laminated to the intermediate layer.

3. The memorabilia article of claim 2, wherein the ink-receptive laminate is an adhesive-backed label.

4. The memorabilia article of claim 2, wherein the ink-receptive laminate includes a paper substrate layer, a water-resistant coating, and an ink-receptive coating.

5. The memorabilia article of claim 1, wherein the urethane top layer is coated onto the intermediate layer.

6. The memorabilia article of claim 5, wherein the urethane top layer has a thickness of at least 1/32 inch.

7. The memorabilia article of claim 1, wherein the intermediate layer, the top layer, and the bottom layer have an identical perimeter shape.

8. The memorabilia article of claim 1, wherein the image is a sport celebrity.

9. The memorabilia article of claim 1, wherein the image relates to a sporting event.

10. The memorabilia article of claim 9, wherein the photographic print paper intermediate layer is substantially free of oil and is water soluble.

11. The memorabilia article of claim 1, wherein a fold line is defined in the intermediate layer, and further wherein a thickness of urethane top layer is reduced along the fold line.

12. The memorabilia article of claim 1, wherein the urethane top layer is not present along the fold line.

13. A method of manufacturing a card-type memorabilia article, the method comprising:
providing a photographic print paper layer, the photographic print paper layer including opposing, first and second major surfaces and displaying an image on the first major surface;
coating a layer of urethane over the first major surface; and
applying an ink-receptive laminate over the second major surface;
wherein the image is visible through the urethane layer and an exposed face of the ink-receptive laminate is available for receiving ink and protects the received ink from smudging and smearing.

14. The method of claim 13, wherein applying an ink-receptive laminate includes:
die-cutting a label from a sheet of ink-receptive laminate, the label having a perimeter shape corresponding with a perimeter shape of the photographic print paper layer; and
bonding the label to the photographic print paper layer.

15. The method of claim 14, wherein the step of coating the urethane layer occurs prior to the step of bonding the label.

16. The method of claim 13, wherein the ink-receptive laminate is a paper-based label stock material having an adhesive coating, a water-resistant material, and an ink-receptive coating.

17. The method of claim 13, wherein coating a layer of urethane includes:
providing the urethane in a melted form; and
dispensing the urethane over the first major surface of the photographic print paper.

18. The method of claim 13, wherein coating the urethane includes forming the urethane to a thickness of at least 1/32 inch.

19. The method of claim 13, further comprising:
forming at least one fold line in the photographic print paper;
wherein coating the layer of urethane includes minimizing an amount of urethane applied over the fold line such that upon final construction, the resultant article is foldable along the fold line.

20. The method of claim 19, wherein coating the urethane includes deploying a baffle over the fold line to prevent accumulation of the urethane.
